(19) United States
(12) Patent Application Publication
(10) Pub. No.: US 2024/0303367 A1
(43) Pub. Date: Sep. 12, 2024

(54) SEARCH WITH USER LOCATION OBFUSCATION

(71) Applicant: WhatsApp LLC, Menlo Park, CA (US)

(72) Inventors: Valerii Bogdanov, London (GB); Min Lin, London (GB)

(21) Appl. No.: 17/467,092

(22) Filed: Sep. 3, 2021

(51) Int. Cl. G06F 21/62; G06Q 30/02

(52) U.S. Cl. CPC G06F 21/6245; G06Q 30/0282; G06F 2221/2111

(57) ABSTRACT

Methods, systems, and storage media for obfuscating an exact location of a user include collecting precise location data at a user device; determining, via a software application on the user device, a first circle that contains the precise location of the user; selecting a random point on or in the circle; determine a second circle having the random point as the center of the circle; increasing a size of the second circle; and utilizing, via the software application, the second circle as an approximate location of the user.

### TECHNICAL FIELD

The present disclosure generally relates to search with user location obfuscation, and more particularly to obfuscating an exact location of a user.

### BACKGROUND

Location-based services (LBS) relate to software services utilizing geographic and/or other location information to provide services or information to users. Examples of LBS use cases include navigation software, tracking systems, personalized weather services, social networking services, location-based advertising, and mobile commerce. Location-based mobile commerce services may include providing coupons and/or advertising directed to users based on their current physical location. For example, messaging applications (e.g., SMS) may be used with LBS applications to deliver mobile coupons or discounts to users who are near to advertising restaurants, cafes, movie theatres, and/or other businesses. Depending on jurisdiction, users may be required to provide consent (e.g., one time opt-in) to participate in LBS services.

### BRIEF SUMMARY

The subject disclosure provides for systems and methods for search with user location obfuscation. A user is allowed to receive location-relevant information via her user device without her precise location being transmitted from her user device. For example, a precise location may be converted to an approximate location that conceals a user's actual position but still allows her to receive information from businesses located in her vicinity.

One aspect of the present disclosure relates to a method for obfuscating an exact location of a user. The method may include collecting precise location data at a user device. The method may include determining, via a software application on the user device, a first circle that contains the precise location of the user. The method may include selecting a random point on or in the circle. The method may include determining a second circle having the random point as the center of the circle. The method may include increasing a size of the second circle. The method may include utilizing, via the software application, the second circle as an approximate location of the user.

Another aspect of the present disclosure relates to a system configured for obfuscating an exact location of a user. The system may include one or more hardware processors configured by machine-readable instructions. The processor(s) may be configured to collect precise location data at a user device. The processor(s) may be configured to determine, via a software application on the user device, a first circle that contains the precise location of the user. The processor(s) may be configured to select a random point on or in the circle. The processor(s) may be configured to determine a second circle having the random point as the center of the circle. The processor(s) may be configured to increase a size of the second circle. The processor(s) may be configured to utilize, via the software application, the second circle as an approximate location of the user.

Yet another aspect of the present disclosure relates to a non-transient computer-readable storage medium having instructions embodied thereon, the instructions being executable by one or more processors to perform a method for obfuscating an exact location of a user. The method may include collecting precise location data at a user device. The method may include determining, via a software application on the user device, a first circle that contains the precise location of the user. The method may include selecting a random point on or in the circle. The method may include determining a second circle having the random point as the center of the circle. The method may include increasing a size of the second circle. The method may include utilizing, via the software application, the second circle as an approximate location of the user.

Still another aspect of the present disclosure relates to a system configured for obfuscating an exact location of a user. The system may include means for collecting precise location data at a user device. The system may include means for determining, via a software application on the user device, a first circle that contains the precise location of the user. The system may include means for selecting a random point on or in the circle. The system may include means for determining a second circle having the random point as the center of the circle. The system may include means for increasing a size of the second circle. The system may include means for utilizing, via the software application, the second circle as an approximate location of the user.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIGS. 1 and 2 illustrate example views of an application configured for search with user location obfuscation, in accordance with one or more implementations.

FIGS. 3 and 4 illustrate example process flows for search with user location obfuscation, in accordance with one or more implementations.

FIG. 5 illustrates example geometries associated with facilitating search with user location obfuscation, in accordance with one or more implementations.

FIGS. 6, 7, and 8 illustrate example map views with user location obfuscation, in accordance with one or more implementations.

FIG. 9 illustrates a system configured for search with user location obfuscation, in accordance with one or more implementations

FIG. 10 illustrates an example flow diagram for search with user location obfuscation, according to certain aspects of the disclosure.

FIG. 11 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Personal privacy may be of concern to many mobile device users, particularly their present physical location. Although these users typically have an option not to opt into location-based services (LBS) on their own device, the convenience provided by LBS-enabled mobile applications is often quite compelling to users. As such, a tradeoff exists for many users between concealing their precise location and receiving the benefits facilitated by LBS.

The subject disclosure provides for systems and methods for search with user location obfuscation. A user is allowed to receive location-relevant information via her user device without her precise location being transmitted from her user device. For example, a precise location may be converted to an approximate location that conceals a user's actual position but still allows her to receive information from businesses located in her vicinity.

Implementations described herein address these and other problems by obfuscating users' real location in connection with LBS-enabled applications while still providing location-relevant information to the users. In exemplary implementations, precise location data may be obtained at a user device. A random point within an area (e.g., a circle) containing the user's precise location may be determined at the user device. A second area (e.g., another circle) centered on the random point may be determined at the user device. The second area may be used as an approximate location of the user.

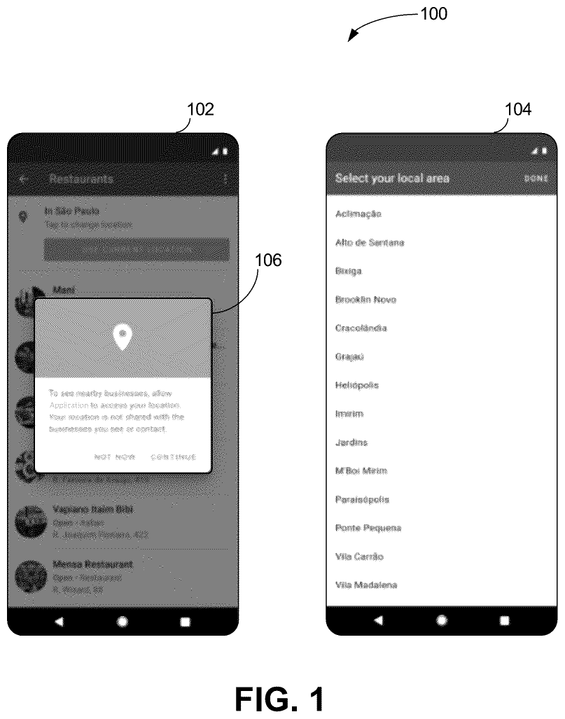

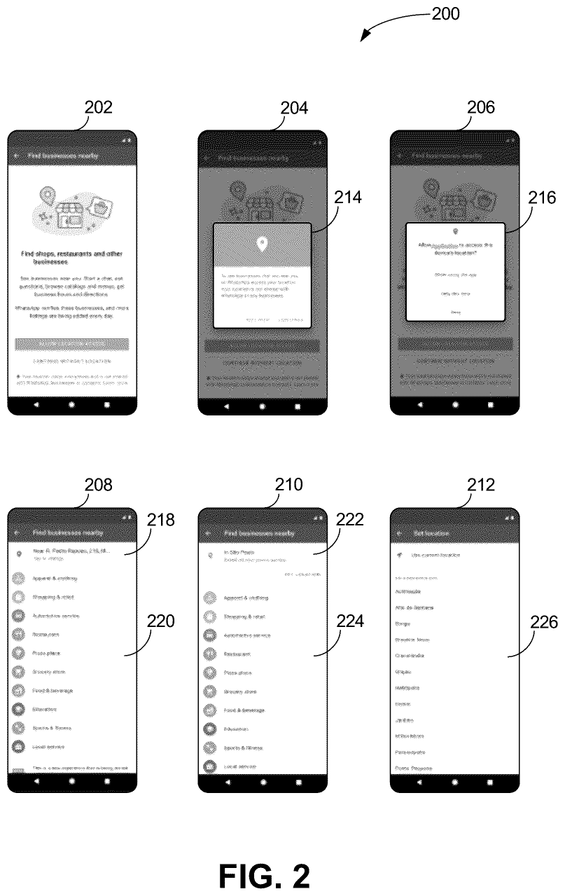

FIGS. 1 and 2 illustrate example views 100 and 200, respectively, of an application configured for search with user location obfuscation, in accordance with one or more implementations. In exemplary implementations, the application will default to using approximate user location. The user may turn off location tracking as well. When tracking is turned off, user will be asked to supply a starting point as a location (e.g., a city, area code, etc.). The views 100 of FIG. 1 include view 102 and view 104, in which a user opts out of location-based services in the application. In view 102, a popup window 106 is presented. The popup window 106 may be presented responsive to a user requesting to search nearby businesses. The popup window 106 may allow the user to select whether to allow the application to access the current location of a user device presenting the view 102. Responsive to the user selecting, via popup window 106, to not allow the application to access the current location of the user device presenting the view 102, the user may be allowed to select a generic location (e.g., a city, a neighborhood, etc.) of view 104.

The views 200 of FIG. 2 include view 202, view 204, view 206, view 208, view 210, and view 212, in which a user opts into location-based services in the application. The view 202 may be presented responsive to the user selecting to “search nearby business” via the application. Through view 202, the user may select whether to allow the application to use the user's location (e.g., the user's exact location) or to continue without letting the application use the user's location. The user can confirm a selection to allow the application to use the user's location through popup window 214 of view 204. In view 206, a popup window 216 may present a system message letting the user to confirm a selection to allow the application to use the user's location. In view 208, an approximate location 218 of the use is shown as well as a list 220 of business categories is presented for selection by the user. Selecting one or more categories may cause the application to present a list of nearby businesses associated with the selected category or categories.

If the user selects to continue without letting the application use the user's location (see view 202), the view 210 may be presented. The view 210 includes the user's present city 222 and a list 224 of business categories located in the city 222. Selecting one or more categories may cause the application to present a list of nearby businesses associated with the selected category or categories. The view 212 may be presented responsive to the user selecting, through view 210, to set a location. The view 212 includes a list 226 of neighborhoods within city 222. The user may be allowed to select one or more neighborhoods in which a search for business should be focused. Responsive to one or neighborhoods being selected, the application may focus search results to businesses located within the selected neighborhood or neighborhoods.

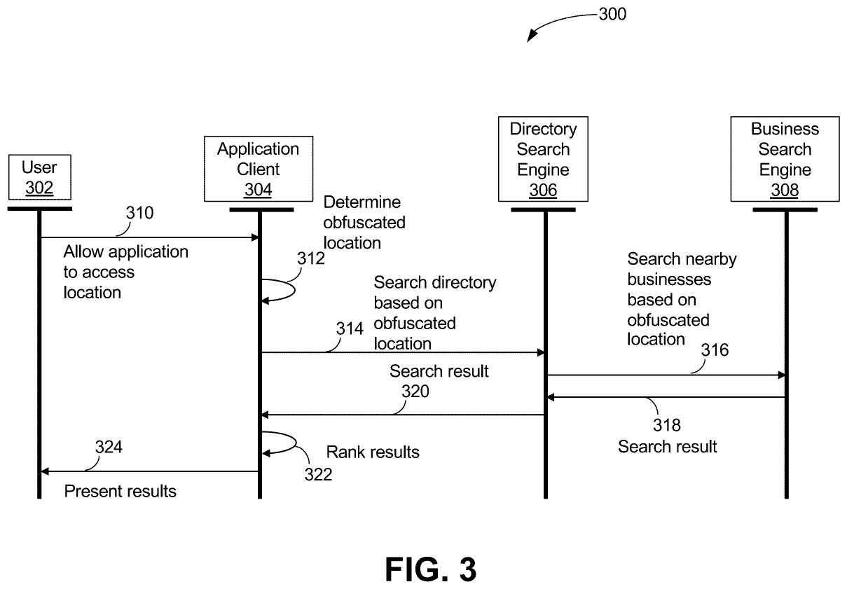

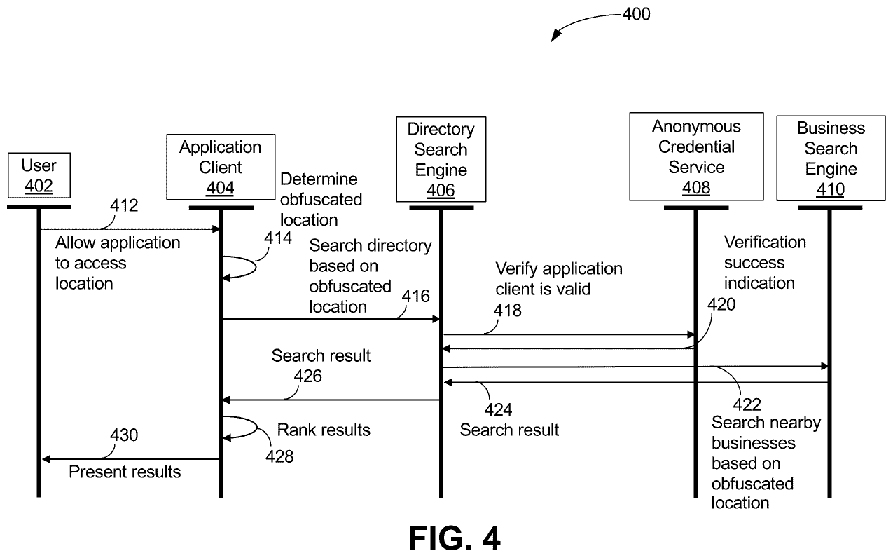

FIGS. 3 and 4 illustrate example process flows 300 and 400, respectively, for search with user location obfuscation, in accordance with one or more implementations. The process flow 300 of FIG. 3 may involve a user 302, an application client 304, a directory search engine 306, a business search engine 308, and/or other components. At a step 310, a request from user 302 may be received by the application client 304 to allow the application to use a location of the user 302. At a step 312, using a precise location of a user device running the application client 304, an obfuscated location of the user 302 may be determined. In exemplary implementations, the precise location of the user device may not be accessed by the application. In some implementations, the precise location data is never directly shared with the application. Precise location data may also be obfuscated itself before being used by the application. The precise location of the user device may not be transmitted away from the user device. It is understood that the precise location of the user may be determined through location tracking application(s)/service(s), such as those included with standard smartphones. It is understood that the precise location information determined by the location tracking application(s)/service(s) are not shared directly with the application client 312.

The obfuscated location may be used, at a step 314, to search a directory of other users of the application (e.g., via the directory search engine 306) whose respective obfuscated locations are within a specified range (e.g., a radius) from the obfuscated location of the user 302 determined at step 312. At a step 316, the obfuscated location of the user 302 may be used to search a directory of businesses located within a specified range (e.g., a radius) from the obfuscated location of the user 302 determined at step 312. At a step 318, a search result (e.g., a list of businesses) may be returned through the directory search engine 306 and, at step 320, on to the application client 304. At a step 322, the search result may be sorted according to one or more factors. Such factors may include one or more of a distance of respective businesses from the obfuscated location of the user 302, a number of contacts of the user 302 located at or near individual businesses, a number of other users of the application located at or near individual businesses, a customer rating of individual businesses, hours of operation of individual businesses, business categories of individual businesses, price ranges of individual businesses, and/or other factors. At a step 324, a sorted list of businesses obtained at step 322 may be presented to the user 302.

The process flow 400 of FIG. 4 may involve a user 402, an application client 404, a directory search engine 406, an anonymous credential service 408, a business search engine 410, and/or other components. At a step 412, a request from user 402 may be received by the application client 404 to allow the application to use a location of the user 402. At a step 414, using a precise location of a user device running the application client 404, an obfuscated location of the user 402 may be determined. In exemplary implementations, the precise location of the user device may not be accessed by the application. In some implementations, the precise location data is never directly shared with the application. Precise location data may also be obfuscated itself before being used by the application. The precise location of the user device may not be transmitted away from the user device. The obfuscated location may be used, at a step 416, to search a directory of other users of the application (e.g., via the directory search engine 406) whose respective obfuscated locations are within a specified range (e.g., a radius) from the obfuscated location of the user 402 determined at step 414. At a step 418, the anonymous credential service 408 may verify that the application client 404 (or information received therefrom) is valid. At a step 420, a verification success indication is provided by the anonymous credential service 408 to the directory search engine 406. At a step 422, the obfuscated location of the user 402 may be used to search a directory of businesses located within a specified range (e.g., a radius) from the obfuscated location of the user 402 determined at step 414. At a step 424, a search result (e.g., a list of businesses) may be returned through the directory search engine 406 and, at step 426, on to the application client 404. At a step 428, the search result may be sorted according to one or more factors. Such factors may include one or more of a distance of respective businesses from the obfuscated location of the user 402, a number of contacts of the user 402 located at or near individual businesses, a number of other users of the application located at or near individual businesses, a customer rating of individual businesses, hours of operation of individual businesses, business categories of individual businesses, price ranges of individual businesses, and/or other factors. At a step 430, a sorted list of businesses obtained at step 428 may be presented to the user 402.

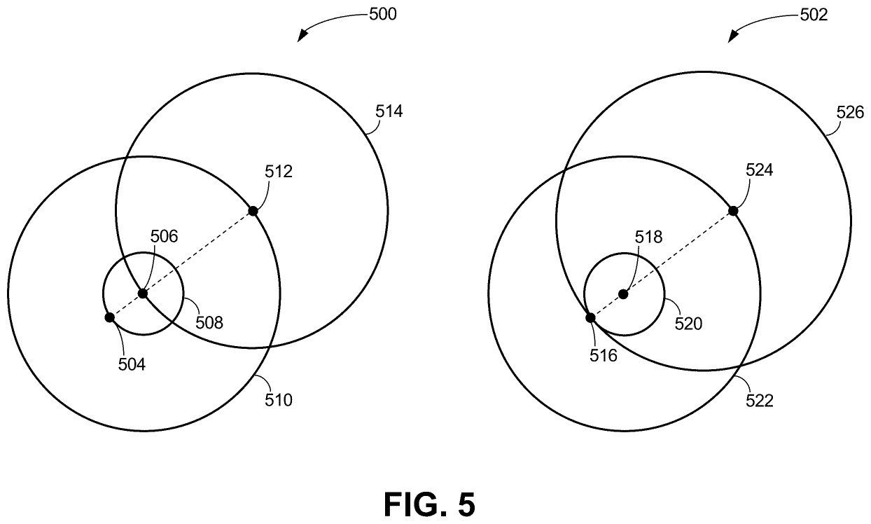

FIG. 5 illustrates example geometries 500 and 502 associated with facilitating search with user location obfuscation, in accordance with one or more implementations. According to geometry 500, a real user location 504 may indicate where a user is, in fact, positioned geographically. A system reported location 506 may be a location determined by a user device of the user. An area of uncertainty 508 (e.g., a circle centered on system reported location 506) may represent a distance of uncertainty attributed to the user device and/or a method for determining location used by the user device. For example, GPS-based location determination can be uncertain by a couple of meters whereas WiFi-based location determination can be uncertain by tens of meters. Still other location determination methods, such as phone number, may only have certainty as to a particular city (or other large geographic area). The real user location 504 within (or on the periphery of) the area of uncertainty 508. A circle 510 (or other shape, such as, including, but not limited to, a triangle, square, rectangle, quadrilateral, polygon, etc.) may be determined that is centered on the system reported location 506 and has a radius between 500 meters and 1000 meters. A radius of 800 meters, for example, would result in the circle 510 having an area of approximately two square kilometers. An imprecise point 512 may be determined at a random point on or within the circle 510. The random point may be determined using a random number generator (e.g., using a known random point generator software routine, etc.). In some implementations, a function (e.g., square root) may be applied to a random number to determine the random point (e.g., taking a square root of the generated random number, etc.). A circle 514 (or other shape) may be centered on the imprecise point 512. In some implementations, the circle 514 may be the same size or larger than the circle 510. The circle 514 may be sized so that it includes a threshold number (e.g., 10,000) other users of the application. In some implementations, the real user location 504 may be positioned within or outside of circle 514.

According to geometry 502 in FIG. 5, a real user location 516 may indicate where a user is, in fact, positioned geographically. A system reported location 518 may be a location determined by a user device of the user. An area of uncertainty 520 (e.g., a circle centered on system reported location 518) may represent a distance of uncertainty attributed to the user device and/or a method for determining location used by the user device. The real user location 516 is within (or on the periphery of) the area of uncertainty 520. A circle 522 (or other shape) may be determined that is centered on the system reported location 518 and has a radius between 500 meters and 1000 meters. An imprecise point 524 may be determined at a random point on or within the circle 522. The random point may be determined using a random number generator. In some implementations, a function (e.g., square root) may be applied to a random number to determine the random point. A circle 526 (or other shape) may be centered on the imprecise point 524. In some implementations, the circle 526 may be the same size or larger than the circle 522. The circle 526 may be sized so that it includes a threshold number (e.g., 10,000) of other users of an application. In some implementations, the real user location 516 may be positioned within or outside of circle 526.

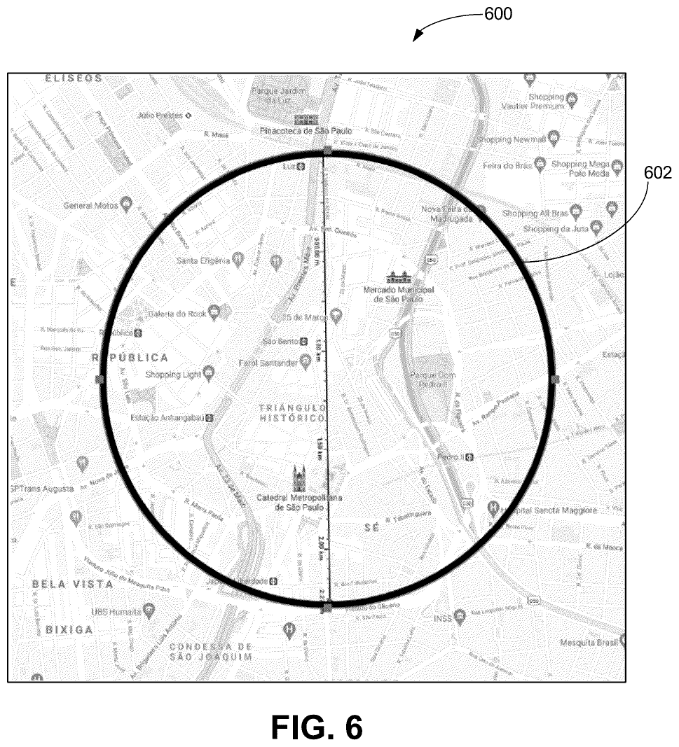

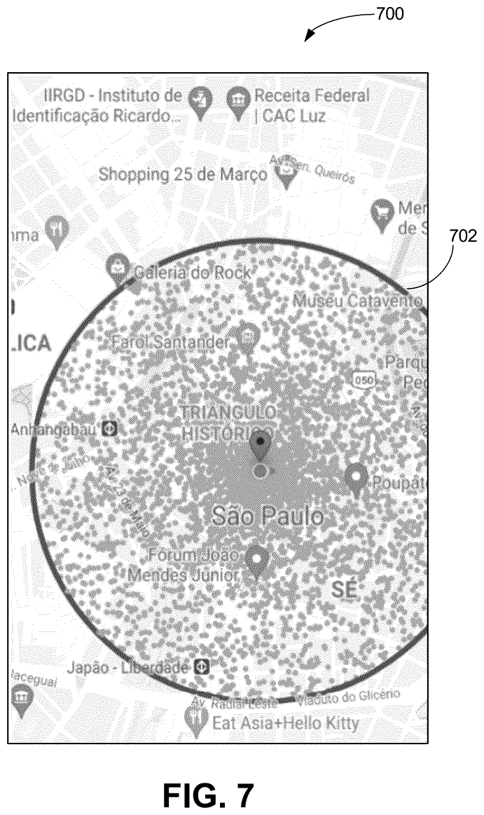

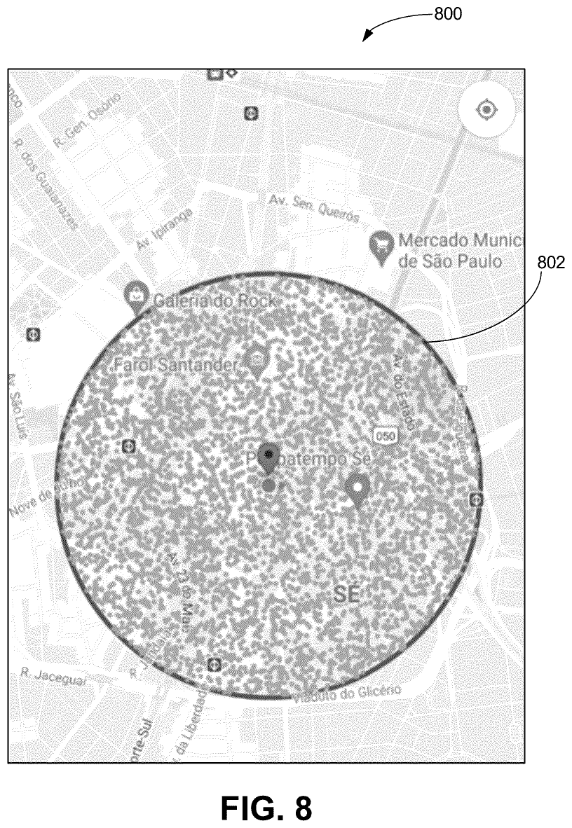

FIGS. 6, 7, and 8 illustrate example map views 600, 700, and 800, respectively, with user location obfuscation, in accordance with one or more implementations. The map view 600 in FIG. 6 shows an imprecise location of a user, which is represented by circle 602. In some implementations, the real location of the user may be on or within circle 602. The map view 700 in FIG. 7 shows an imprecise location of a user, which is represented by a circle 702. In some implementations, the real location of the user may be on or within the circle 702. The plurality of dots shown in the circle 702 may represent possible locations of real users (e.g., 10,000 real users) of an application on their mobile devices. The map view 800 in FIG. 8 shows an imprecise location of a user, which is represented by a circle 802. In some implementations, the real location of the user may be on or within the circle 802. The plurality of dots shown in the circle 802 may represent possible locations of real users (e.g., 10,000 real users) of an application on their mobile devices. The circle 602 of FIG. 6, the circle 702 of FIG. 7, and the circle 802 of FIG. 8 cover approximately the same geographic area depicted in the different map views 600, 700, and 800. In the circle 702 and circle 802, the dots are in different locations reflecting changes in possible positions of real users (e.g., at different times of the day).

The disclosed system(s) address a problem in traditional search with user location obfuscation techniques tied to computer technology, namely, the technical problem of providing location-relevant information to a user device without revealing a precise location of a user of the user device. The disclosed system solves this technical problem by providing a solution also rooted in computer technology, namely, by providing for obfuscating an exact location of a user. The disclosed subject technology further provides improvements to the functioning of the computer itself because it improves processing and efficiency in search with user location obfuscation.

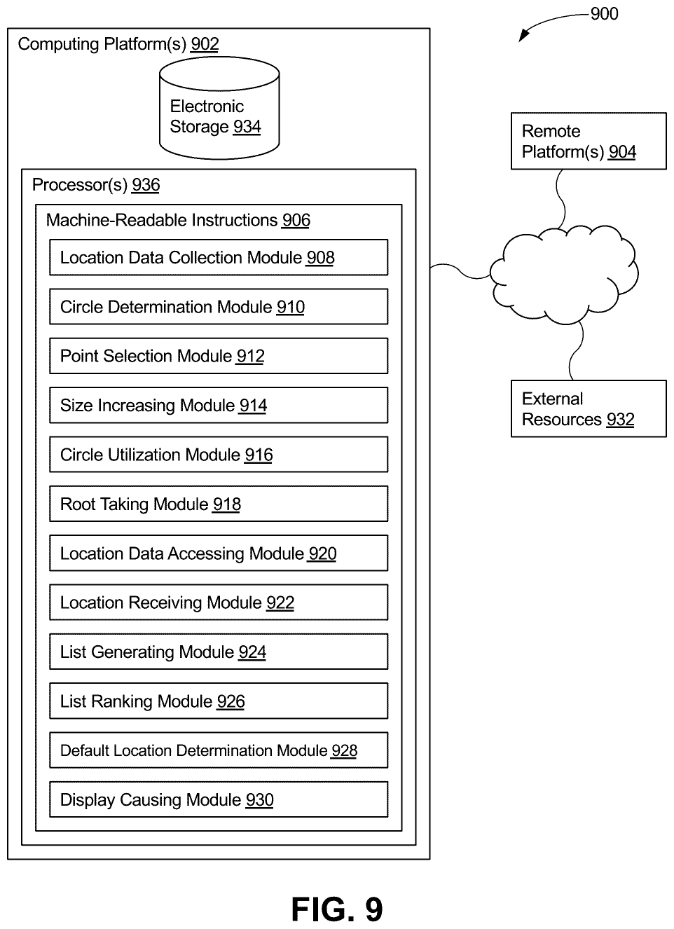

FIG. 9 illustrates a system 900 configured for search with user location obfuscation, according to certain aspects of the disclosure. In some implementations, system 900 may include one or more computing platforms 902. Computing platform(s) 902 may be configured to communicate with one or more remote platforms 904 according to a client/server architecture, a peer-to-peer architecture, and/or other architectures. Remote platform(s) 904 may be configured to communicate with other remote platforms via computing platform(s) 902 and/or according to a client/server architecture, a peer-to-peer architecture, and/or other architectures. Users may access system 900 via remote platform(s) 904.

Computing platform(s) 902 may be configured by machine-readable instructions 906. Machine-readable instructions 906 may include one or more instruction modules. The instruction modules may include computer program modules. The instruction modules may include one or more of location data collection module 908, circle determination module 910, point selection module 912, size increasing module 914, circle utilization module 916, root taking module 918, location data accessing module 920, location receiving module 922, list generating module 924, list ranking module 926, default location determination module 928, display causing module 930, and/or other instruction modules.

Location data collection module 908 may be configured to collect precise location data at a user device. The precise location data of the user device may indicate a geographic location of the user device. The precise location data may be accessed at the user device. The precise location data may be stored at the user device. The precise location data may be retained only by the user device. In some implementations, the precise location data is never directly shared with the application. Precise location data may also be obfuscated itself before being used by the application.

Circle determination module 910 may be configured to determine, via a software application on the user device, a first circle that contains the precise location of the user. The first circle may have a radius of between five hundred and one thousand meters. The first circle may demarcate a first circular shaped geographic area in which the user device is physically located. The first circle may have a radius of approximately eight hundred meters. The first circle may have an area of approximately two kilometers.

Point selection module 912 may be configured to select a random point on or in the circle. A random number generator may be used to determine the random point.

Circle determination module 910 may be configured to determine a second circle having the random point as the center of the circle. The second circle may be offset from the first circle. The second circle may demarcate a second circular shaped geographic area. A distance of the offset may equal a distance between an actual location of the user and an obfuscated approximate location of the user.

Size increasing module 914 may be configured to increase a size of the second circle. By way of non-limiting example, increasing the size of the second circle may include at least one of increasing an area, circumference, radius, or diameter of the second circle. The size of the second circle may be increased by up to 15% of an original size of the second circle. The size of the second circle may be increased such that it contains locations associated with a threshold number of other user devices. The threshold number of other user devices may be approximately ten thousand.

Circle utilization module 916 may be configured to utilize, via the software application, the second circle as an approximate location of the user. The approximate location of the user may be selected from a plurality of potential location points on or within the second circle. The approximate location of the user may be used by a software application enabled by location-based services running on the user device.

Root taking module 918 may be configured to take a square root of a value associated with the random point. In some implementations, root taking module 918 may be configured to apply other functions (e.g., cubic, quadratic, linear, non-linear, etc.) to the value associated with the random point. Applying a function to the value may create more “randomness” and/or more significant figures.

Location data accessing module 920 may be configured to access the precise location data through a software application. The precise location data may be not shared with the software application. An identity of the user may be hidden through the software application. The identity of the user may include personally identifiable information. The personally identifiable information may include information which can be used to distinguish or trace an individual's identity. By way of non-limiting example, the personally identifiable information may include one or more of name, social security number, biometric records, date and place of birth, or mother's maiden name.

Location receiving module 922 may be configured to receive, from the user, an approximate starting location. The approximate starting location may be based at least in part on an area code of the user. The approximate starting location may include a specific neighborhood in a city.

List generating module 924 may be configured to generate a list of businesses that are on or within the second circle.

List ranking module 926 may be configured to rank the list of businesses based on a distance from the approximate location of the user.

Default location determination module 928 may be configured to determine a default location of the user based at least in part on the user's phone number.

Display causing module 930 may be configured to cause display of the second circle over a map of a city.

In some implementations, computing platform(s) 902, remote platform(s) 904, and/or external resources 932 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 902, remote platform(s) 904, and/or external resources 932 may be operatively linked via some other communication media.

A given remote platform 904 may include one or more processors configured to execute computer program modules. The computer program modules may be configured to enable an expert or user associated with the given remote platform 904 to interface with system 900 and/or external resources 932, and/or provide other functionality attributed herein to remote platform(s) 904. By way of non-limiting example, a given remote platform 904 and/or a given computing platform 902 may include one or more of a server, a desktop computer, a laptop computer, a handheld computer, a tablet computing platform, a NetBook, a Smartphone, a gaming console, and/or other computing platforms.

External resources 932 may include sources of information outside of system 900, external entities participating with system 900, and/or other resources. In some implementations, some or all of the functionality attributed herein to external resources 932 may be provided by resources included in system 900.

Computing platform(s) 902 may include electronic storage 934, one or more processors 936, and/or other components. Computing platform(s) 902 may include communication lines, or ports to enable the exchange of information with a network and/or other computing platforms. Illustration of computing platform(s) 902 in FIG. 9 is not intended to be limiting. Computing platform(s) 902 may include a plurality of hardware, software, and/or firmware components operating together to provide the functionality attributed herein to computing platform(s) 902. For example, computing platform(s) 902 may be implemented by a cloud of computing platforms operating together as computing platform(s) 902.

Electronic storage 934 may comprise non-transitory storage media that electronically stores information. The electronic storage media of electronic storage 934 may include one or both of system storage that is provided integrally (i.e., substantially non-removable) with computing platform(s) 902 and/or removable storage that is removably connectable to computing platform(s) 902 via, for example, a port (e.g., a USB port, a firewire port, etc.) or a drive (e.g., a disk drive, etc.). Electronic storage 934 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 934 may include one or more virtual storage resources (e.g., cloud storage, a virtual private network, and/or other virtual storage resources). Electronic storage 934 may store software algorithms, information determined by processor(s) 936, information received from computing platform(s) 902, information received from remote platform(s) 904, and/or other information that enables computing platform(s) 902 to function as described herein.

Processor(s) 936 may be configured to provide information processing capabilities in computing platform(s) 902. As such, processor(s) 936 may include one or more of a digital processor, an analog processor, a digital circuit designed to process information, an analog circuit designed to process information, a state machine, and/or other mechanisms for electronically processing information. Although processor(s) 936 is shown in FIG. 9 as a single entity, this is for illustrative purposes only. In some implementations, processor(s) 936 may include a plurality of processing units. These processing units may be physically located within the same device, or processor(s) 936 may represent processing functionality of a plurality of devices operating in coordination. Processor(s) 936 may be configured to execute modules 908, 910, 912, 914, 916, 918, 920, 922, 924, 926, 928, and/or 930, and/or other modules. Processor(s) 936 may be configured to execute modules 908, 910, 912, 914, 916, 918, 920, 922, 924, 926, 928, and/or 930, and/or other modules by software; hardware; firmware; some combination of software, hardware, and/or firmware; and/or other mechanisms for configuring processing capabilities on processor(s) 936. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 908, 910, 912, 914, 916, 918, 920, 922, 924, 926, 928, and/or 930 are illustrated in FIG. 9 as being implemented within a single processing unit, in implementations in which processor(s) 936 includes multiple processing units, one or more of modules 908, 910, 912, 914, 916, 918, 920, 922, 924, 926, 928, and/or 930 may be implemented remotely from the other modules. The description of the functionality provided by the different modules 908, 910, 912, 914, 916, 918, 920, 922, 924, 926, 928, and/or 930 described below is for illustrative purposes, and is not intended to be limiting, as any of modules 908, 910, 912, 914, 916, 918, 920, 922, 924, 926, 928, and/or 930 may provide more or less functionality than is described. For example, one or more of modules 908, 910, 912, 914, 916, 918, 920, 922, 924, 926, 928, and/or 930 may be eliminated, and some or all of its functionality may be provided by other ones of modules 908, 910, 912, 914, 916, 918, 920, 922, 924, 926, 928, and/or 930. As another example, processor(s) 936 may be configured to execute one or more additional modules that may perform some or all of the functionality attributed below to one of modules 908, 910, 912, 914, 916, 918, 920, 922, 924, 926, 928, and/or 930.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

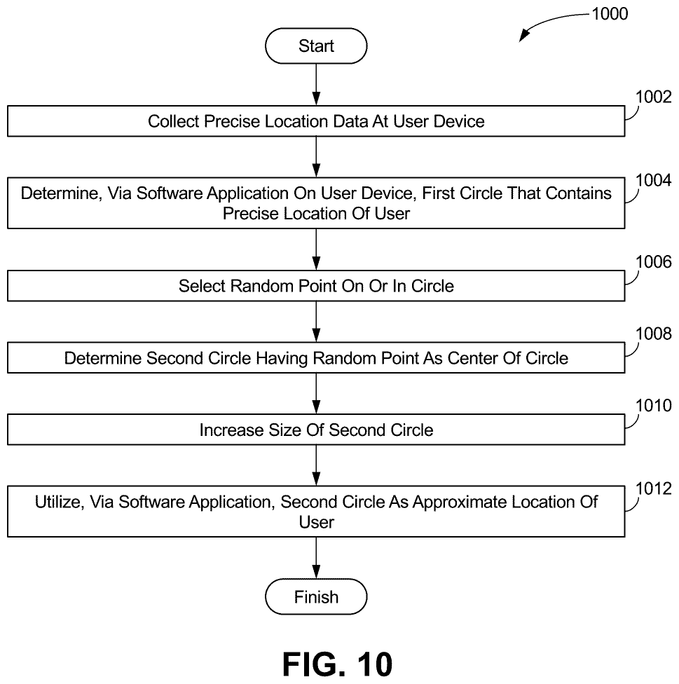

FIG. 10 illustrates an example flow diagram (e.g., process 1000) for search with user location obfuscation, according to certain aspects of the disclosure. For explanatory purposes, the example process 1000 is described herein with reference to FIGS. 1-9. Further for explanatory purposes, the steps of the example process 1000 are described herein as occurring in serial, or linearly. However, multiple instances of the example process 1000 may occur in parallel. For purposes of explanation of the subject technology, the process 1000 will be discussed in reference to FIGS. 1-9.

At step 1002, the process 1000 may include collecting precise location data at a user device. At step 1004, the process 1000 may include determining, via a software application on the user device, a first circle that contains the precise location of the user. At step 1006, the process 1000 may include selecting a random point on or in the circle. At step 1008, the process 1000 may include determining a second circle having the random point as the center of the circle. At step 1010, the process 1000 may include increasing a size of the second circle. At step 1012, the process 1000 may include utilizing, via the software application, the second circle as an approximate location of the user.

For example, as described above in relation to FIGS. 1-9, at step 1002, the process 1000 may include collecting precise location data at a user device, through location data collection module 908. At step 1004, the process 1000 may include determining, via a software application on the user device, a first circle that contains the precise location of the user, through circle determination module 910. At step 1006, the process 1000 may include selecting a random point on or in the circle, through point selection module 912. At step 1008, the process 1000 may include determining a second circle having the random point as the center of the circle, through circle determination module 910. At step 1010, the process 1000 may include increasing a size of the second circle, through size increasing module 914. At step 1012, the process 1000 may include utilizing, via the software application, the second circle as an approximate location of the user, through circle utilization module 916.

According to an aspect, the first circle has a radius of between five hundred and one thousand meters.

According to an aspect, the process 1000 further includes taking a square root of a value associated with the random point.

According to an aspect, the process 1000 further includes accessing the precise location data through a software application.

According to an aspect, the precise location data is not shared with the software application.

According to an aspect, the process 1000 further includes receiving, from the user, an approximate starting location.

According to an aspect, the approximate starting location is based at least in part on an area code of the user.

According to an aspect, the process 1000 further includes generating a list of businesses that are on or within (e.g., proximate to) the second circle.

According to an aspect, the process 1000 further includes ranking the list of businesses based on a distance from the approximate location of the user.

According to an aspect, the approximate location of the user is selected from a plurality of potential location points on or within the second circle.

According to an aspect, an identity of the user is hidden through the software application.

According to an aspect, increasing the size of the second circle comprises at least one of increasing an area, circumference, radius, or diameter of the second circle.

According to an aspect, the size of the second circle is increased by up to 15% of an original size of the second circle.

According to an aspect, the process 1000 further includes determining a default location of the user based at least in part on the user's phone number.

According to an aspect, the approximate starting location comprises a specific neighborhood in a city.

According to an aspect, the process 1000 further includes causing display of the second circle over a map of a city.

According to an aspect, the second circle is offset from the first circle.

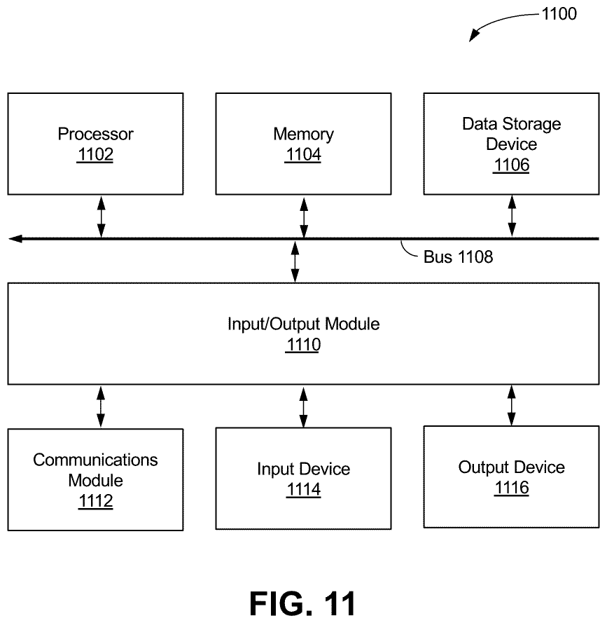

FIG. 11 is a block diagram illustrating an exemplary computer system 1100 with which aspects of the subject technology can be implemented. In certain aspects, the computer system 1100 may be implemented using hardware or a combination of software and hardware, either in a dedicated server, integrated into another entity, or distributed across multiple entities.

Computer system 1100 (e.g., server and/or client) includes a bus 1108 or other communication mechanism for communicating information, and a processor 1102 coupled with bus 1108 for processing information. By way of example, the computer system 1100 may be implemented with one or more processors 1102. Processor 1102 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1100 can include, in addition to hardware, code that creates an execution environment for the computer program in question, e.g., code that constitutes processor firmware, a protocol stack, a database management system, an operating system, or a combination of one or more of them stored in an included memory 1104, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1108 for storing information and instructions to be executed by processor 1102. The processor 1102 and the memory 1104 can be supplemented by, or incorporated in, special purpose logic circuitry.

The instructions may be stored in the memory 1104 and implemented in one or more computer program products, i.e., one or more modules of computer program instructions encoded on a computer-readable medium for execution by, or to control the operation of, the computer system 1100, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1104 may also be used for storing temporary variable or other intermediate information during execution of instructions to be executed by processor 1102.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1100 further includes a data storage device 1106 such as a magnetic disk or optical disk, coupled to bus 1108 for storing information and instructions. Computer system 1100 may be coupled via input/output module 1110 to various devices. The input/output module 1110 can be any input/output module. Exemplary input/output modules 1110 include data ports such as USB ports. The input/output module 1110 is configured to connect to a communications module 1112. Exemplary communications modules 1112 include networking interface cards, such as Ethernet cards and modems. In certain aspects, the input/output module 1110 is configured to connect to a plurality of devices, such as an input device 1114 and/or an output device 1116. Exemplary input devices 1114 include a keyboard and a pointing device, e.g., a mouse or a trackball, by which a user can provide input to the computer system 1100. Other kinds of input devices 1114 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1116 include display devices such as an LCD (liquid crystal display) monitor, for displaying information to the user.

According to one aspect of the present disclosure, the above-described gaming systems can be implemented using a computer system 1100 in response to processor 1102 executing one or more sequences of one or more instructions contained in memory 1104. Such instructions may be read into memory 1104 from another machine-readable medium, such as data storage device 1106. Execution of the sequences of instructions contained in the main memory 1104 causes processor 1102 to perform the process steps described herein. One or more processors in a multi-processing arrangement may also be employed to execute the sequences of instructions contained in memory 1104. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1100 can include clients and servers. A client and server are generally remote from each other and typically interact through a communication network. The relationship of client and server arises by virtue of computer programs running on the respective computers and having a client-server relationship to each other. Computer system 1100 can be, for example, and without limitation, a desktop computer, laptop computer, or tablet computer. Computer system 1100 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1102 for execution. Such a medium may take many forms, including, but not limited to, non-volatile media, volatile media, and transmission media. Non-volatile media include, for example, optical or magnetic disks, such as data storage device 1106. Volatile media include dynamic memory, such as memory 1104. Transmission media include coaxial cables, copper wire, and fiber optics, including the wires that comprise bus 1108. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1100 reads game data and provides a game, information may be read from the game data and stored in a memory device, such as the memory 1104. Additionally, data from the memory 1104 servers accessed via a network, the bus 1108, or the data storage 1106 may be read and loaded into the memory 1104. Although data is described as being found in the memory 1104, it will be understood that data does not have to be stored in the memory 1104 and may be stored in other memory accessible to the processor 1102 or distributed among several media, such as the data storage 1106.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A computer-implemented method for obfuscating an exact location of a user, comprising:
collecting on a processor precise location data at a user device, via a global positioning system (GPS) associated with the processor;
determining, via a software application on the processor, a first circle that contains the precise location of the user via the global positioning system;
identifying a threshold number of users associated with the software application;
selecting a random point on or in the first circle;
determining a second circle having the random point as the center of the second circle;
increasing a size of the second circle based on the threshold number of users; and
utilizing, via the software application, the second circle as an approximate location of the user.

2. The method of claim 1, wherein the first circle has a radius of between five hundred and one thousand meters.

3. The method of claim 1, further comprising:
taking a square root of a value associated with the random point.

4. The method of claim 1, further comprising:
accessing the precise location data through a software application.

5. The method of claim 1, wherein the precise location data is not shared with the software application.

6. The method of claim 1, further comprising:
receiving, from the user, an approximate starting location.

7. The method of claim 6, wherein the approximate starting location is based at least in part on an area code of the user.

8. The method of claim 1, further comprising:
generating a list of businesses that are on or within the second circle.

9. The method of claim 8, further comprising:
ranking the list of businesses based on a distance from the approximate location of the user.

10. The method of claim 1, wherein the approximate location of the user is selected from a plurality of potential location points on or within the second circle.

11. A system configured for obfuscating an exact location of a user, the system comprising:
one or more hardware processors configured by machine-readable instructions to:
collect precise location data at a user device via a global positioning system associated with the user device;
determine, via a software application on the user device, a first circle that contains the precise location of the user;
identify a threshold number of users associated with the software application;
select a random point on or in the first circle;
determine a second circle having the random point as the center of the second circle;
increase a size of the second circle based on the threshold number of users; and
utilize, via the software application, the second circle as an approximate location of the user.

12. The system of claim 11, wherein the first circle has a radius of between five hundred and one thousand meters.

13. The system of claim 11, wherein the one or more hardware processors are further configured by machine-readable instructions to:
take a square root of a value associated with the random point.

14. The system of claim 11, wherein the one or more hardware processors are further configured by machine-readable instructions to:
access the precise location data through a software application.

15. The system of claim 11, wherein the precise location data is not shared with the software application.

16. The system of claim 11, wherein the one or more hardware processors are further configured by machine-readable instructions to:
receive, from the user, an approximate starting location.

17. The system of claim 16, wherein the approximate starting location is based at least in part on an area code of the user.

18. The system of claim 11, wherein the one or more hardware processors are further configured by machine-readable instructions to:
generate a list of businesses that are on or within the second circle.

19. The system of claim 18, wherein the one or more hardware processors are further configured by machine-readable instructions to:
rank the list of businesses based on a distance from the approximate location of the user, wherein the approximate location of the user is selected from a plurality of potential location points on or within the second circle.

20. A non-transient computer-readable storage medium having instructions embodied
thereon, the instructions being executable by one or more processors to perform a method for obfuscating an exact location of a user, the method comprising:
collecting on the one or more processor precise location data at a user device, via a global positioning system (GPS) associated with the processor;
determining, via a software application on the one or more processors, a first circle that contains the precise location of the user via the global positioning system;
identifying a threshold number of users associated with the software application;
selecting a random point on or in the first circle;
determining a second circle having the random point as the center of the second circle;
increasing a size of the second circle based on the threshold number of users; and
utilizing, via the software application, the second circle as an approximate location of the user.
